(19) United States
(12) Patent Application Publication
(10) Pub. No.: US 2026/0058565 A1
(43) Pub. Date: Feb. 26, 2026

(54) MIXED-MODE OPERATION METHOD APPLIED TO DC POWER CONVERTER

(71) Applicant: ASIAN POWER DEVICES INC., Taoyuan City (TW)

(72) Inventor: Tsung-Liang HUNG, Taoyuan City (TW)

(21) Appl. No.: 19/009,569

(22) Filed: Jan. 3, 2025

(30) Foreign Application Priority Data
Aug. 26, 2024 (TW) 113132042

(51) Int. Cl. H02M 3/335; H02M 1/00; H02M 3/00

(52) U.S. Cl. CPC H02M 3/33571; H02M 1/0022; H02M 3/01

(57) ABSTRACT

A mixed-mode operation method is applied to a DC power converter. The DC power converter receives an input voltage, and the input voltage is between a minimum voltage and a maximum voltage. The method includes steps of: operating the DC power converter in a SRC mode when the input voltage is greater than a lower threshold voltage and less than an upper threshold voltage; operating the DC power converter in an LLC mode when the input voltage is less than the lower threshold voltage; operating the DC power converter in the LLC mode when the input voltage is greater than the upper threshold voltage.

### BACKGROUND

### Technical Field

The present disclosure relates to a mixed-mode operation method, and more particularly to a mixed-mode operation method applied to a DC power converter.

### Description of Related Art

The statements in this section merely provide background information related to the present disclosure and do not necessarily constitute prior art.

Resonant converters can use resonant tanks to shape the waveforms of switching voltage and/or switching current to minimize switching losses and enable high-frequency operation. Since resonant converters have advantages, such as high efficiency, simple structure that can be realized by integrating magnetic components, soft switching on the primary-side switches and secondary-side switches, and suitability for applications in a wide voltage range, etc., they can be widely used as an isolated DC-to-DC converter.

However, how to take into account efficiency, the selection of low withstand voltage rated components, and better hold-up time are the development directions that those skilled in the art attach great importance to and seek technical means to achieve.

Therefore, how to design a mixed-mode operation method applied to a DC power converter to solve the problems and technical bottlenecks in the existing technology has become a critical topic in this field.

### SUMMARY

An objective of the present disclosure is to provide a mixed-mode operation method. The mixed-mode operation method is applied to a DC power converter. The DC power converter receives an input voltage, and the input voltage is between a minimum voltage and maximum voltage. The method includes steps of: operating the DC power converter in a SRC mode when the input voltage is greater than a lower threshold voltage and less than an upper threshold voltage, wherein the lower threshold voltage is greater than the minimum voltage, and the upper threshold voltage is less than the maximum voltage, operating the DC power converter in an LLC mode when the input voltage is less than the lower threshold voltage, and operating the DC power converter in the LLC mode when the input voltage is greater than the upper threshold voltage.

In one embodiment, the method further includes steps of: operating the DC power converter in the SRC mode or the LLC mode when the input voltage is equal to the lower threshold voltage, and operating the DC power converter in the SRC mode or the LLC mode when the input voltage is equal to the upper threshold voltage.

In one embodiment, when the DC power converter operates in the SRC mode, a switching frequency of operating the DC power converter is substantially fixed.

In one embodiment, when the DC power converter operates in the SRC mode, a ratio between an output voltage and the input voltage of the DC power converter is substantially fixed.

In one embodiment, the switching frequency is a first resonant frequency of the DC power converter at the highest efficiency.

In one embodiment, the DC power converter includes a resonant tank, the resonant tank includes a resonant inductor, a resonant capacitor, and a magnetizing inductor of a transformer, wherein the first resonant frequency:

$$fr 1 = \frac{- 1}{2 π \sqrt{{L}_{r} \times {C}_{r}}} ,$$

where fr1 is the first resonant frequency, Lr is the resonant inductor, Cr is the resonant capacitor.

In one embodiment, when the DC power converter operates in the LLC mode, a ratio between a switching frequency of operating the DC power converter and the input voltage is substantially fixed.

In one embodiment, when the DC power converter operates in the LLC mode, an output voltage of operating the DC power converter is substantially fixed.

In one embodiment, when the input voltage reaches the upper threshold voltage, the output voltage is correspondingly an output upper limit voltage, and the output upper limit voltage is an upper limit voltage of a step-down converter downstream connected to DC power converter. In one embodiment, when the input voltage reaches the lower threshold voltage, the output voltage is correspondingly an output lower limit voltage, and the output lower limit voltage is a lower limit voltage of a step-down converter downstream connected to the DC power converter.

Therefore, the mixed-mode operation method of the present disclosure achieves the features and advantages of taking into account efficiency, the selection of low withstand voltage rated components, and better hold-up time.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block diagram of a two-stage DC-to-DC power conversion structure.

FIG. 2 is a schematic waveform diagram of a relationship between a switching frequency and an input voltage when a DC power converter operates in a SRC mode and an LLC mode according to the present disclosure.

FIG. 3 is a schematic waveform diagram of a relationship between an output voltage and the input voltage when the DC power converter operates in the SRC mode and the LLC mode according to the present disclosure.

FIG. 4 is a circuit diagram of the DC power converter according to an embodiment of the present disclosure.

FIG. 5 is a schematic waveform diagram of a relationship between the switching frequency and the input voltage when the DC power converter operates is in a mixed-mode operation according to the present disclosure.

FIG. 6 is a schematic waveform diagram of a relationship between the output voltage and the input voltage when the DC power converter operates is in the mixed-mode operation according to the present disclosure.

FIG. 7 is a schematic waveform diagram compared with FIG. 2 and FIG. 5.

FIG. 8 is a schematic waveform diagram compared with FIG. 3 and FIG. 6.

FIG. 9 is a schematic waveform diagram of a relationship between a voltage gain and the switching frequency of the DC power converter according to the present disclosure.

FIG. 10 is a flowchart of a mixed-mode operation method according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

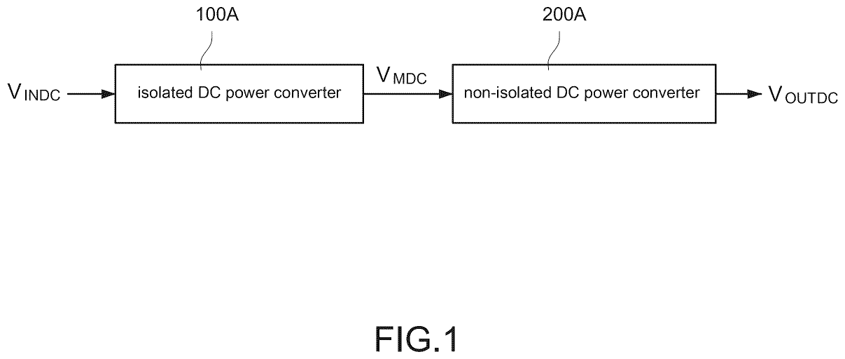

Please refer to FIG. 1, which shows a block diagram of a two-stage DC-to-DC power conversion structure. As shown in FIG. 1, the DC-to-DC power conversion structure has a two-stage structure connected in series. The first stage serves as an isolation function (i.e., an isolated DC power converter 100A), and the second stage (i.e., a non-isolated DC power converter 200A) outputs low voltage to a load terminal. In particular, the isolated DC power converter 100A receives an input voltage V_{INDC}, and converts the input voltage V_{INDC} into an intermediate voltage V_{MDC}. The non-isolated DC power converter 200A receives the intermediate voltage V_{MDC}, and converts the intermediate voltage V_{MDC} into an output voltage V_{OUTDC}.

For example, the first-stage isolated DC power converter 100A in FIG. 1 is an LLC converter (or conversion circuit) with a stable output function. When the input voltage V_{INDC} changes (i.e., changes between the minimum voltage Vin(min) and the maximum voltage Vin(max)), it can still maintain a fixed output voltage, namely, the fixed intermediate voltage V_{MDC}. To achieve a change in the output voltage, the voltage gain is changed by changing frequency. However, its disadvantage is that the frequency range is wide, and therefore it cannot operate at the optimal efficiency point at all times, that is, it cannot maintain at the first resonance point.

Taking another circuit implementation as an example. For example, the first-stage isolated DC power converter 100A in FIG. 1 uses a series resonance converter (SRC, also known as a bus converter). Compared with LLC converters, SRC converters operate at a fixed frequency, and therefore a ration between the output voltage and the input voltage is a fixed value, that is, the output voltage changes proportionally with the input voltage. In other words, the SRC converter cannot stabilize the output voltage, and therefore the load voltage stabilization may can only be accomplished by the second-stage non-isolated power converter 200A (such as a step-down (buck) converter). Since the SRC converter is at a fixed frequency, it can maintain the optimal conversion efficiency at any operating point, which is the advantage of the SRC converter.

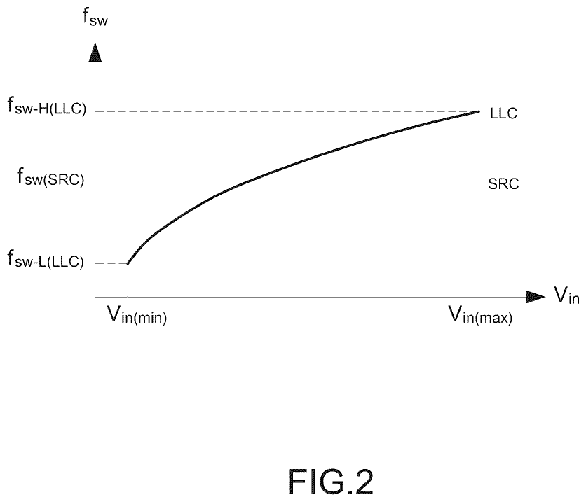

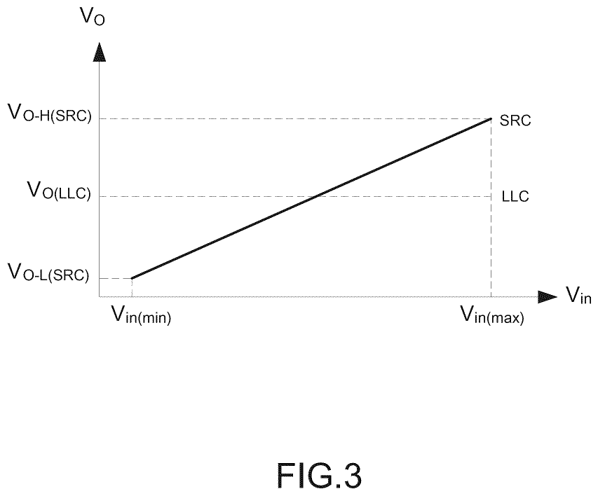

Please refer to FIG. 2 and FIG. 3, which respectively show a schematic waveform diagram of a relationship between a switching frequency and an input voltage when a DC power converter operates in a SRC mode and an LLC mode according to the present disclosure, and a schematic waveform diagram of a relationship between an output voltage and the input voltage when the DC power converter operates in the SRC mode and the LLC mode according to the present disclosure. The specific explanations and principles can be combined with the previous disclosure.

Although the SRC converter has high conversion efficiency, when the input voltage is low, the output voltage of the second-stage buck converter also decreases simultaneously. In this condition, the capacitor stores less energy, which will result in a shorter hold-up time. Therefore, compared with LLC converters, the use of SRC converters must add more capacitors, but this also causes the problem of increased volume. On the other hand, when the input voltage is high, the output voltage of the SRC converter is high, and the input of the second-stage buck converter must withstand high input voltages, requiring the use of more expensive high withstand voltage rated components. For LLC converters, this problem does not occur since the output voltage is fixed.

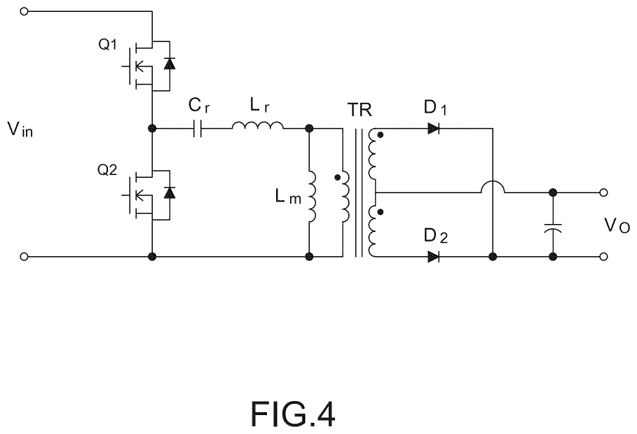

Please refer to FIG. 4, which shows a circuit diagram of the DC power converter according to an embodiment of the present disclosure. The DC power converter is an isolated DC power converter, which includes three parts: the first part is a switch network, the second part is a resonant tank, and a third part is a rectifier circuit. Specifically, the switch network includes a first switch Q₁ and a second switch Q₂. The first switch Q₁ and the second switch Q₂ are connected in series at a common node, and the series-connected switch network receives an input voltage V_{IN}.

The resonant tank includes a resonant inductor Lr, a resonant capacitor Cr, and a magnetizing inductor Lm of a transformer TR. In particular, transformer TR is used as electrical isolation and participates in resonance. The resonant inductor Lr is connected to the resonant capacitor Cr in series, and the series-connected resonant inductor Lr and resonant capacitor Cr is connected to between the magnetizing inductor Lm and a common node between the first switch Q₁ and the second switch Q₂.

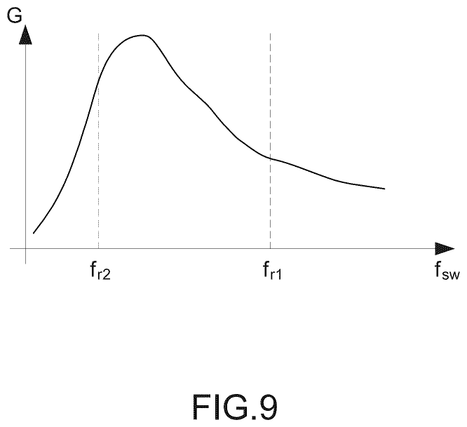

Furthermore, please refer to FIG. 9, which shows a schematic waveform diagram of a relationship between a voltage gain and the switching frequency of the DC power converter according to the present disclosure. More specifically, it is a waveform diagram illustrating the relationship between a voltage gain and a switching frequency in a resonant tank operation. As mentioned above, the resonant tank of the isolated DC power converter of the present disclosure mainly consists of the resonant inductor Lr, the resonant capacitor Cr, and the magnetizing inductor Lm. In particular, the first resonant frequency fr1 is determined by the resonant inductor Lr and the resonant capacitor Cr, that is, the magnetizing inductor Lm does not participate in the resonance effect. Therefore, the first resonant frequency:

$$fr 1 = \frac{1}{2 π \sqrt{{L}_{r} \times {C}_{r}}} ,$$

where fr1 is the first resonant frequency, Lr is the resonant inductor, Cr is the resonant capacitor. Moreover, the second resonant frequency fr2 is determined by the resonant inductor Lr, the resonant capacitor Cr, and the magnetizing inductor Lm. Therefore,

$$fr 2 = \frac{1}{2 π ( {L}_{r} + {L}_{m} ) \times {C}_{r}} ,$$

where fr2 is the second resonant frequency, Lr is the resonant inductor, Lm is the magnetizing inductor, Cr is the resonant capacitor.

It can be seen from FIG. 9 that the characteristics of the LLC conversion circuit structure are that the right half plane of the maximum gain point is the inductive region, and the left half plane thereof is the capacitive region. Under the inductive region operation, the lower the switching frequency (or operating frequency) fsw (that is, toward the lower frequency), the greater the voltage gain G of the LLC conversion circuit; on the contrary, the greater the switching frequency fsw (that is, toward the higher frequency), the smaller the voltage gain G of the LLC conversion circuit. At the first resonant frequency fr1, it is unity gain (that is, voltage gain G=1).

Please refer to FIG. 4 again, the third part of the rectifier circuit of the isolated DC power converter is formed on the secondary side of the transformer TR and mainly consists of rectifier diodes D1,D2. However, the present disclosure is not limited to the rectifier circuit of FIG. 4.

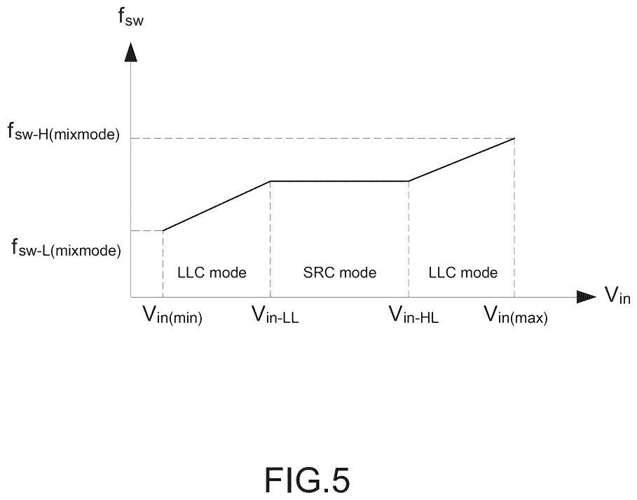

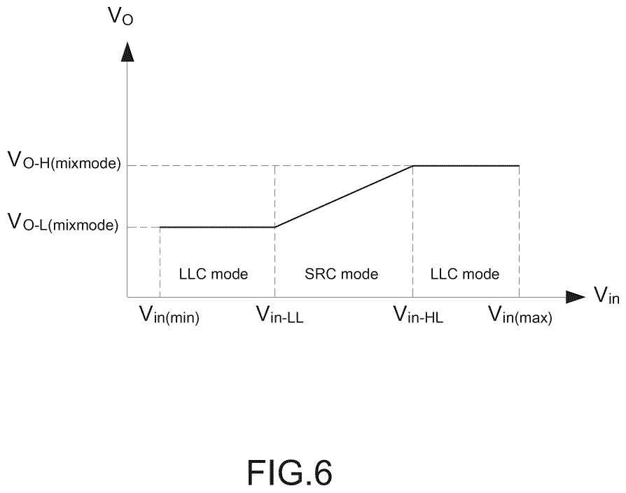

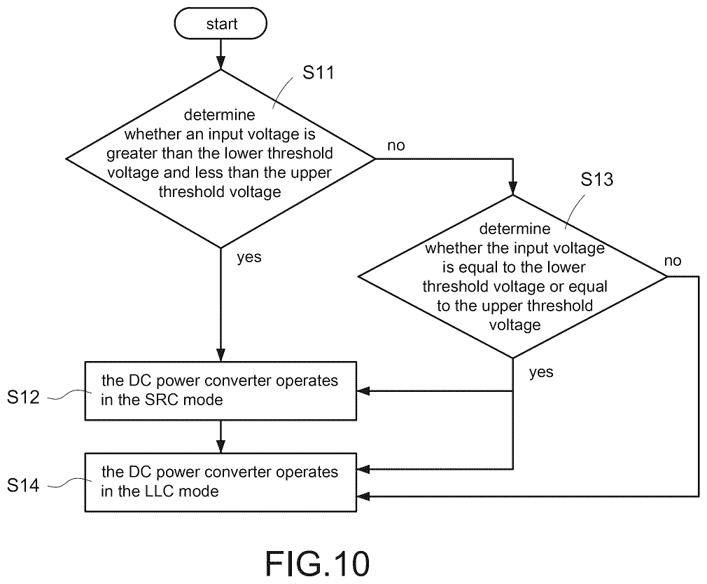

Please refer to FIG. 10, which shows a flowchart of a mixed-mode operation method according to the present disclosure. The so-called “mixed mode operation” means that the DC power converter is controlled to operate in different modes in response to different input voltages so that the DC power converter achieves the advantages of taking into account efficiency, the selection of low withstand voltage rated components, and better hold-up time. Please refer to FIG. 5, which shows a schematic waveform diagram of a relationship between the switching frequency and the input voltage when the DC power converter operates is in a mixed-mode operation according to the present disclosure; please refer to FIG. 6, which shows a schematic waveform diagram of a relationship between the output voltage and the input voltage when the DC power converter operates is in the mixed-mode operation according to the present disclosure. Specific descriptions are as follows.

The mixed-mode operation method of the present disclosure is applied to the DC power converter. The DC power converter receives an input voltage Vin, and the input voltage Vin is between a minimum voltage Vin(min) and a maximum voltage Vin(max). As shown in FIG. 10, the mixed-mode operation method includes steps as follows. It is to determine whether the input voltage Vin is greater than a lower threshold voltage V_{in-LL} and less than an upper threshold voltage V_{in-HL} (step S11). In particular, the lower threshold voltage V_{in-LL} is greater than the minimum voltage Vin(min), and the upper threshold voltage V_{in-HL} is less than the maximum voltage Vin(max).

If the determination result of step S11 is “yes”, that is, when the input voltage Vin is greater than the lower threshold voltage V_{in-LL} and less than the upper threshold voltage V_{in-HL}, the DC power converter operates in a SRC (series resonance conversion) mode (step S12). In the SRC mode, a switching frequency fsw of operating the DC power converter is substantially fixed. As shown in FIG. 5, the switching frequency fsw is a horizontal fixed value when the input voltage Vin is between the lower threshold voltage V_{in-LL} and the upper threshold voltage V_{in-HL}, and the switching frequency is a first resonant frequency of the DC power converter at the highest efficiency. For example, the DC power converter includes a resonant tank, and the resonant tank includes the resonant inductor Lr and the resonant capacitor Cr connected in series, and the magnetizing inductor Lm. Therefore, the first resonant frequency:

$$fr 1 = \frac{- 1}{2 π \sqrt{{L}_{r} \times {C}_{r}}} ,$$

where fr1 is the first resonant frequency, Lr is the resonant inductor, Cr is the resonant capacitor.

Moreover, when the DC power converter operates in the SRC mode, a ratio between an output voltage Vo and the input voltage Vin of the DC power converter is substantially fixed. As shown in FIG. 6, when the input voltage Vin is between the lower threshold voltage V_{in-LL} and the upper threshold voltage V_{in-HL}, as the input voltage Vin increases, the output voltage Vo also proportionally increases; on the contrary, as the input voltage Vin decreases, the output voltage Vo also proportionally decreases. Incidentally, the so-called “substantially fixed” mentioned above means that under ideal conditions, the switching frequency is fixed, or the ratio between the output voltage and the input voltage is fixed. However, if actual non-ideal conditions are considered, it can be seen that the switching frequency is almost fixed, or the ratio between the output voltage and the input voltage is almost fixed.

When the input voltage Vin reaches the upper threshold voltage V_{in-HL}, the output voltage Vo reaches an upper limit of operating the second-stage step-down (buck) converter, that is, the output upper limit voltage Vo-H(mixmode), and the output upper limit voltage Vo-H(mixmode) is kept. Therefore, even if the input voltage Vin continues to increase, the output voltage Vo can be stabilized at Vo-H(mixmode), and it is helpful to select low withstand voltage rated components for the second-stage step-down (buck) converter. Similarly, when the input voltage Vin reaches the lower threshold voltage V_{in-LL}, the output voltage Vo reaches a lower limit of operating the second-stage step-down (buck) converter, that is, the output lower limit voltage Vo-L (mixmode), and the output lower limit voltage Vo-L (mixmode) is kept. Therefore, even if the input voltage Vin continues to decrease, the output voltage Vo can be stabilized at Vo-L (mixmode), and it is helpful to extend the hold-up time of the second-stage step-down (buck) converter.

However, if the determination result of step S11 is “no”, that is, when the input voltage Vin is less than or equal to the lower threshold voltage V_{in-LL} or greater than or equal to the upper threshold voltage V_{in-HL}, it is to determine whether the input voltage Vin is equal to the lower threshold voltage V_{in-LL} or equal to the upper threshold voltage V_{in-HL} (step S13). If the determination result of step S13 is “no”, that is, when the input voltage Vin is less than the lower threshold voltage V_{in-LL} or greater than the upper threshold voltage V_{in-HL}, the DC power converter operates in an LLC (inductor-inductor-capacitor) mode (step S14). In the LLC mode, a ratio between a switching frequency of operating the DC power converter and the input voltage Vin is substantially fixed. As shown in FIG. 5, when the input voltage Vin is less than the lower threshold voltage V_{in-LL}, the switching frequency fsw also proportionally increases as the input voltage Vin increases; on the contrary, the switching frequency fsw also proportionally decreases as the input voltage Vin decreases. Similarly, when the input voltage Vin is greater than the upper threshold voltage V_{in-HL}, the switching frequency fsw also proportionally increases as the input voltage Vin increases; on the contrary, the switching frequency fsw also proportionally decreases as the input voltage Vin decreases.

In addition, when the DC power converter operates in the LLC mode, the output voltage Vo of the DC power converter is substantially fixed. As shown in FIG. 6, the output voltage Vo is a horizontal fixed value when the input voltage Vin is less than the lower threshold voltage V_{in-LL}. Similarly, the output voltage Vo is a horizontal fixed value when the input voltage Vin is greater than the upper threshold voltage V_{in-HL}.

Incidentally, if the determination result of step S13 is “yes”, that is, when the input voltage Vin is equal to the lower threshold voltage V_{in-LL} or equal to the upper threshold voltage V_{in-HL}, the DC power converter may operate in the SRC mode (step S12) or in the LLC mode (step S14). In other words, when the input voltage Vin is exactly the voltage at which the operating mode transitions, both conversion modes may be used.

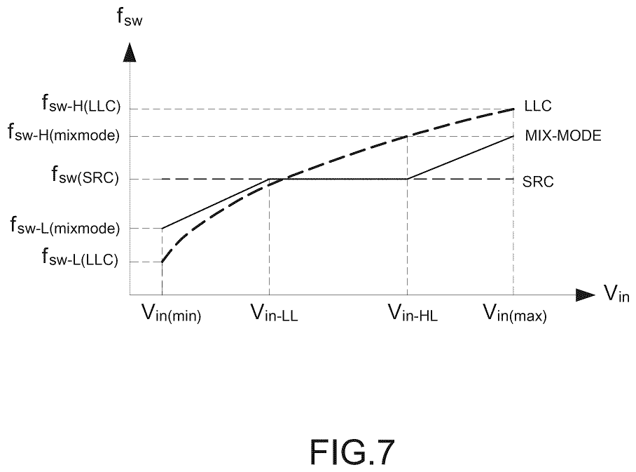

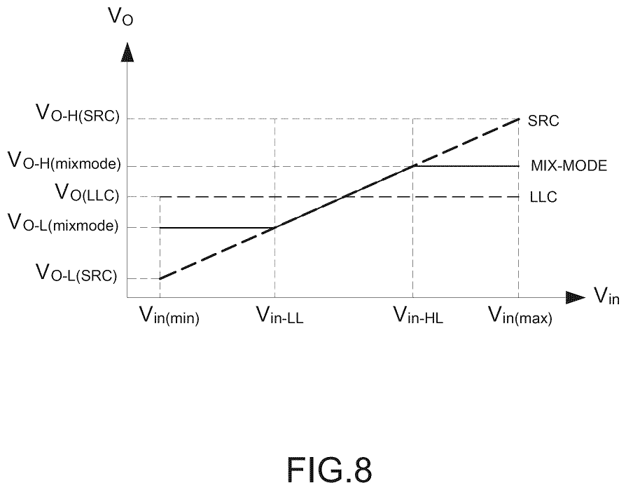

Please refer to FIG. 7 and FIG. 8, which respectively show a schematic waveform diagram compared with FIG. 2 and FIG. 5 and a schematic waveform diagram compared with FIG. 3 and FIG. 6. According to the mixed-mode operation method adopted in the present disclosure (i.e., the MIX-MODE curves shown in FIG. 5 and FIG. 6), the advantages of LLC mode and SRC mode can be combined. That is, when the input voltage Vin is between the lower threshold voltage V_{in-LL} and the upper threshold voltage V_{in-HL}, the DC power converter operates in the SRC mode, and when the input voltage Vin is not between the lower threshold voltage V_{in-LL} and the upper threshold voltage V_{in-HL} (i.e., the input voltage Vin is less than the lower threshold voltage V_{in-LL} or the input voltage Vin is greater than the upper threshold voltage V_{in-HL}), the DC power converter operates in the LLC mode, thereby taking into account efficiency, the selection of low withstand voltage rated components, and better hold-up time.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A mixed-mode operation method, applied to a DC power converter, wherein the DC power converter is configured to receive an input voltage, and the input voltage is between a minimum voltage and maximum voltage, the method comprising steps of:
operating the DC power converter in a SRC mode when the input voltage is greater than a lower threshold voltage and less than an upper threshold voltage, wherein the lower threshold voltage is greater than the minimum voltage, and the upper threshold voltage is less than the maximum voltage,
operating the DC power converter in an LLC mode when the input voltage is less than the lower threshold voltage, and
operating the DC power converter in the LLC mode when the input voltage is greater than the upper threshold voltage.

2. The mixed-mode operation method as claimed in claim 1, further comprising steps of:
operating the DC power converter in the SRC mode or the LLC mode when the input voltage is equal to the lower threshold voltage, and
operating the DC power converter in the SRC mode or the LLC mode when the input voltage is equal to the upper threshold voltage.

3. The mixed-mode operation method as claimed in claim 1, wherein when the DC power converter operates in the SRC mode, a switching frequency of operating the DC power converter is substantially fixed.

4. The mixed-mode operation method as claimed in claim 1, wherein when the DC power converter operates in the SRC mode, a ratio between an output voltage and the input voltage of the DC power converter is substantially fixed.

5. The mixed-mode operation method as claimed in claim 3, wherein the switching frequency is a first resonant frequency of the DC power converter at the highest efficiency.

6. The mixed-mode operation method as claimed in claim 5, wherein the DC power converter comprises a resonant tank, the resonant tank comprises a resonant inductor, a resonant capacitor, and a magnetizing inductor of a transformer,
wherein the first resonant frequency:
$$fr 1 = \frac{1}{2 π \sqrt{{L}_{r} \times {C}_{r}}} ,$$
where fr1 is the first resonant frequency, Lr is the resonant inductor, Cr is the resonant capacitor.

7. The mixed-mode operation method as claimed in claim 1, wherein when the DC power converter operates in the LLC mode, a ratio between a switching frequency of operating the DC power converter and the input voltage is substantially fixed.

8. The mixed-mode operation method as claimed in claim 1, wherein when the DC power converter operates in the LLC mode, an output voltage of the DC power converter is substantially fixed.

9. The mixed-mode operation method as claimed in claim 4, wherein when the input voltage reaches the upper threshold voltage, the output voltage is correspondingly an output upper limit voltage, and the output upper limit voltage is an upper limit voltage of a step-down converter downstream connected to DC power converter.

10. The mixed-mode operation method as claimed in claim 4, wherein when the input voltage reaches the lower threshold voltage, the output voltage is correspondingly an output lower limit voltage, and the output lower limit voltage is a lower limit voltage of a step-down converter downstream connected to the DC power converter.
